(19) United States
(12) Patent Application Publication
(10) Pub. No.: US 2025/0166595 A1
(43) Pub. Date: May 22, 2025

(54) SOUND ATTENUATING COMPRESSOR JACKET

(71) Applicant: Rheem Manufacturing Company, Atlanta, GA (US)

(72) Inventor: Sohail Ahmed, Montgomery, AL (US)

(21) Appl. No.: 18/950,413

(22) Filed: Nov. 18, 2024

Related U.S. Application Data
(60) Provisional application No. 63/601,390, filed on Nov. 21, 2023.

(51) Int. Cl. G10K 11/16

(52) U.S. Cl. CPC G10K 11/16

(57) ABSTRACT

A jacket is disclosed for use with a compressor of a heat transfer system. The compressor is configured to operate and emit sound over a frequency band during operation. The jacket includes: an inner wall configured to surround the compressor, a middle layer, and an outer layer. The inner wall includes a first material and has a plurality of openings configured to attenuate a first volume of a first frequency within the frequency band of the sound. The middle layer is configured to surround the inner wall and includes a second material configured to attenuate a second volume of a second frequency within the frequency band of the sound. The outer layer is configured to surround the middle layer.

### CROSS-REFERENCE TO RELATED APPLICATION

This application claims priority to U.S. Provisional Application No. 63/601,390, filed Nov. 21, 2023, which is hereby incorporated in its entirety.

### FIELD

This application relates generally heat transfer systems and more particularly to systems and methods to attenuate sound from compressors of heat transfer systems.

### BACKGROUND

Compressors of heat transfer systems (such as heat pumps, air conditioners, or the like) are configured to compress refrigerant gas, thereby raising the refrigerant gas temperature and increasing the refrigerant gas pressure. This process may allow the heat transfer systems to transfer heat using the principals of a vapor compression cycle. However, compressors may produce a lot of noise while active and compressing the refrigerant gas and releasing the compressed gas through a valve into the discharge tube that allows compressor refrigerant to flow through the coils for the heat transfer. This process produces valve vibrations and noise (within the compressor) and may also resonate the shell of the compressor and piping. Accordingly, there is a desire to eliminate or decrease the sound emitted from the compressor.

### BRIEF DESCRIPTION OF THE FIGURES

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A illustrates a perspective view of a compressor jacket in accordance with one or more embodiments of the present disclosure.

FIG. 1B illustrates a top view of the compressor jacket of FIG. 1A in accordance with one or more embodiments of the present disclosure.

FIG. 2 illustrates a cross-sectional view of the compressor jacket of FIG. 1A in accordance with one or more embodiments of the present disclosure.

FIG. 3 illustrates an example heat transfer system in accordance with one or more embodiments of the present disclosure.

FIG. 4 illustrates an example heat transfer system in accordance with one or more embodiments of the present disclosure.

FIG. 5A illustrates an audio test setup including a microphone and a sound device in accordance with one or more embodiments of the present disclosure.

FIG. 5B illustrates a sound graph associated with the audio test set up of FIG. 5A in accordance with one or more embodiments of the present disclosure.

FIG. 5C illustrates an audio test set up including a microphone and a compressor jacket in accordance with one or more embodiments of the present disclosure.

FIG. 5D illustrates a sound graph associated with the audio test setup of FIG. 5C in accordance with one or more embodiments of the present disclosure.

FIG. 6A illustrates another audio test set up including a microphone and a sound device in accordance with one or more embodiments of the present disclosure.

FIG. 6B illustrates a sound graph associated with the audio test setup of FIG. 6A in accordance with one or more embodiments of the present disclosure.

FIG. 6C illustrates another audio test set up including a microphone and a compressor jacket in accordance with one or more embodiments of the present disclosure.

FIG. 6D illustrates a sound graph associated with the audio test setup of FIG. 6C in accordance with one or more embodiments of the present disclosure.

FIG. 7A illustrates another audio test setup including a microphone and a sound device in accordance with one or more embodiments of the present disclosure.

FIG. 7B illustrates a sound graph associated with the test setup of FIG. 7A in accordance with one or more embodiments of the present disclosure.

FIG. 7C illustrates another audio test setup including a microphone and a compressor jacket in accordance with one or more embodiments of the present disclosure.

FIG. 7D illustrates a sound graph associated the test setup of FIG. 7C in accordance with one or more embodiments of the present disclosure.

FIG. 8A illustrates another audio test setup including a microphone and a sound device in accordance with one or more embodiments of the present disclosure.

FIG. 8B illustrates a sound graph associated with the audio test setup of FIG. 8A.

FIG. 8C illustrates an audio test setup including microphone and a compressor jacket in accordance with one or more embodiments of the present disclosure.

FIG. 8D illustrates a sound graph associated with the audio test setup of FIG. 8C in accordance with one or more embodiments of the present disclosure.

### DETAILED DESCRIPTION

In certain embodiments, a compressor jacket is disclosed. The compressor jacket may be configured to be positioned about (e.g., at least partially surround) a compressor (and in some instances other components, e.g., an accumulator) of a heat transfer system. In some instances, the heat transfer system may include a heat pump for a water heater. At least some of the components of the heat pump (e.g., the compressor and/or the accumulator) may be located in a housing of the water heater. In some instances, the heat pump water heater may be tankless. In other instances, the water heater may include a water tank for storing heated water. In such instances, the housing may be disposed above the water tank of the water heater. The compressor jacket may be positioned about the compressor and/or the accumulator within the housing. In this manner, the compressor jacket may be configured to eliminate or at least partially attenuate sound from the compressor and/or the accumulator of the heat transfer system when the compressor is operating.

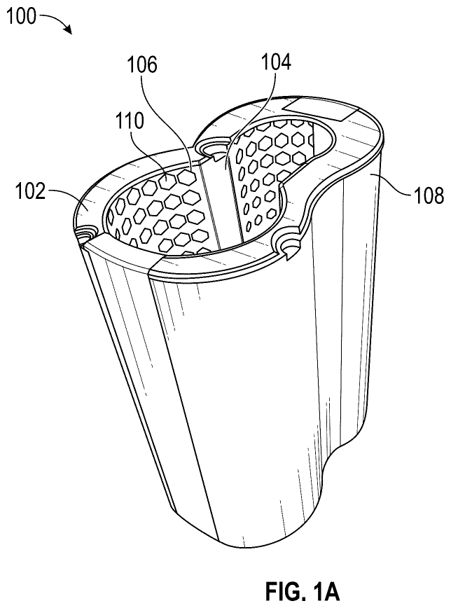

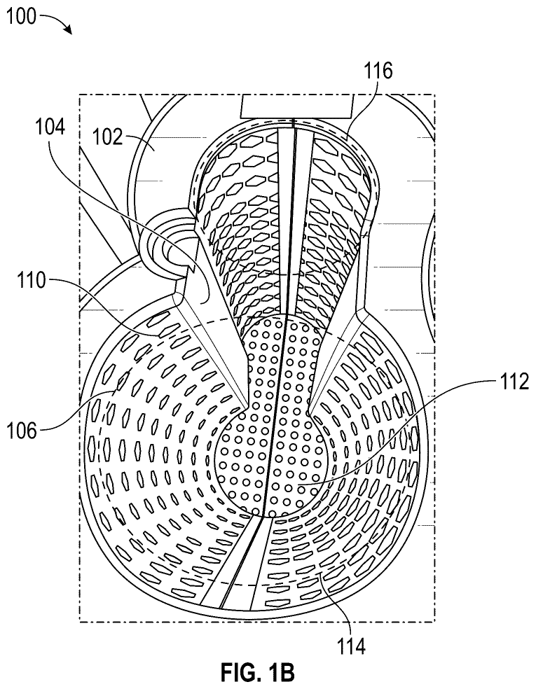

Turning now to the drawings, FIG. 1A illustrates a perspective view of a compressor jacket 100 in accordance with one or more embodiments of the present disclosure. The compressor jacket 100 is depicted upside down in FIG. 1A. The compressor jacket 100 may include a base 102, an inner layer 104, a middle layer 106, and an outer layer 108. The compressor jacket 100 may be configured to be placed over top a compressor and/or an accumulator of a heat transfer system, such as a heat pump or the like of a water heater. In some instances, the compressor jacket 100 may wholly or partially cover the compressor and/or the accumulator.

In some instances, the base 102 may be configured to rest on a surface on which the compressor and/or the accumulator resides. For example, the compressor and/or the accumulator may be disposed within a housing of the water heater. The housing may include a floor (or base plate) on which one or more components of the heat pump (e.g., the compressor and/or the accumulator) may be located. The base 102 of the compressor jacket 100 may be configured to rest on the floor of the housing and form a seal therewith to reduce noise. In some instances, the base 102 may include a vibration reducing pad that is configured to reduce the vibrations of the compressor and/or the accumulator. The vibration reducing pad may be made from any number of different types of materials. The vibration reducing pad may also be any number of different types of shapes and/or sizes. The material, size, shape, etc. may be based on various factors, such as the size and shape of the base 102 and/or any other number of factors.

The inner layer 104 of the compressor jacket 100 may include a plastic material, for example a plastic material selected from a group of plastic materials comprising one or more of thermoplastic polyurethane (TPU), polyethylene terephthalate (PET), acrylonitrile butadiene styrene (ABS), thermoplastic elastomers (TPE), and combinations thereof. Any suitable plastic material may be used herein. The inner layer 104 may include a plurality of holes 110 that expose the middle layer 106. In certain instances, the size, shape, and configuration of the plurality of holes in the inner layer 104 are configured to break lower frequency sound waves into smaller frequency sound waves. Each sound wave is a transverse wave (at higher frequencies and not the low frequencies) and has a tendency to change in frequency and break into the multiple signals/waves of different frequencies when it passes through different materials and geometries/paths. Hole size is a factor and may be chosen as a function of the velocity of pressure wave, wavelength to attenuate, the length of the path etc. That is, any number of different types of hole shapes and/or sizes may be used. In one embodiment, the shape of the plurality of holes in the inner layer 104 may be hexagonal, which provides significant tonal reduction.

The middle layer 106 may include a fiber layer configured to attenuate predetermined tones or frequencies within a band of frequencies. In certain embodiments, the middle layer 106 may include an acoustic absorption foam, melamine, polyurethane, and a high density fiber glass, such as a glass wool fiber or the like. Glass wool fiber is a type of insulation made from glass fibers. The fibers are arranged using a binder into a texture similar to wool. Glass wool is produced in rolls or in slabs, with different thermal and mechanical properties. It may also be produced as a material that can be sprayed or applied in place, on the surface to be insulated. The middle layer may also include any other type of material as well.

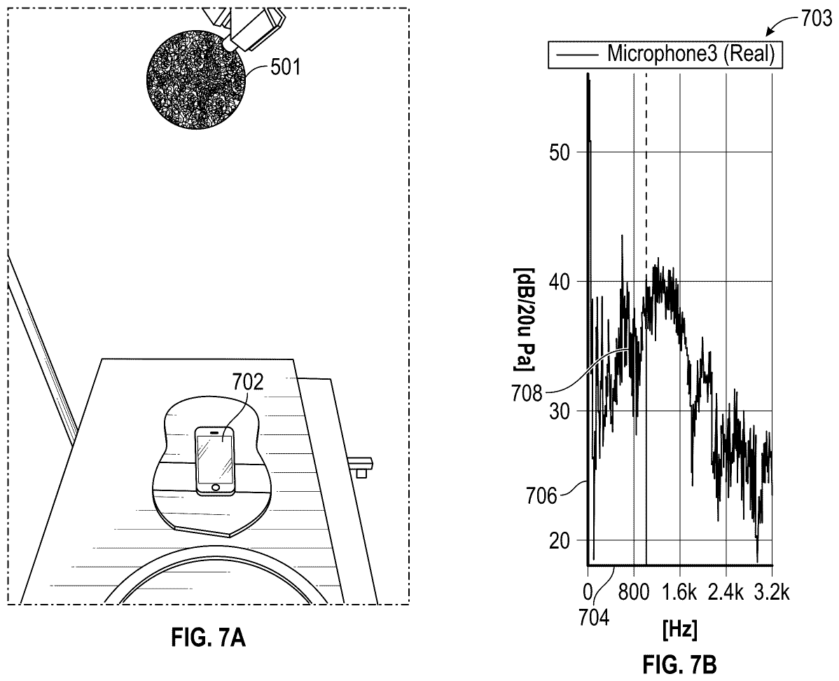

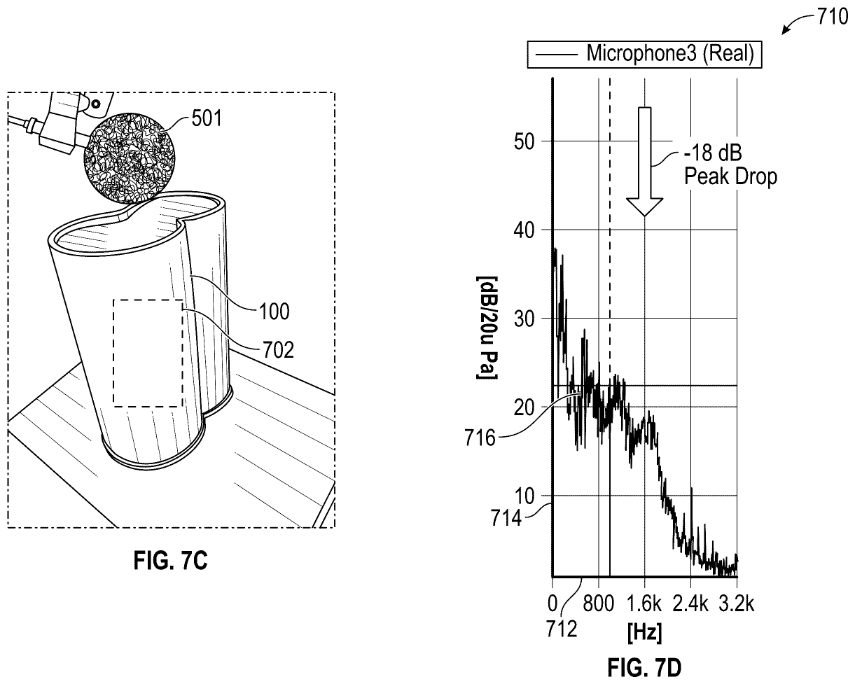

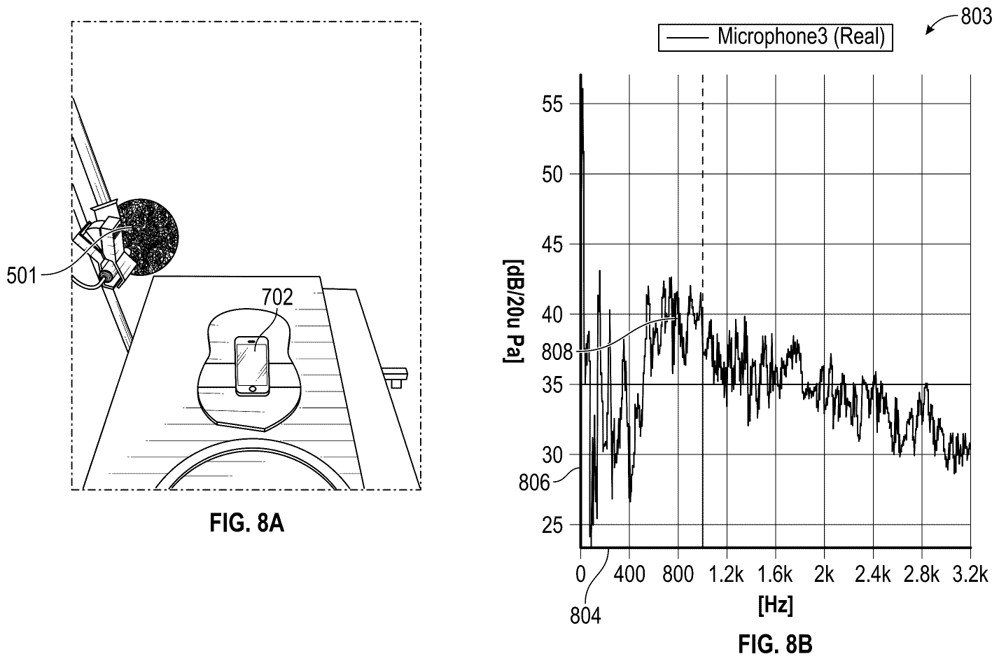

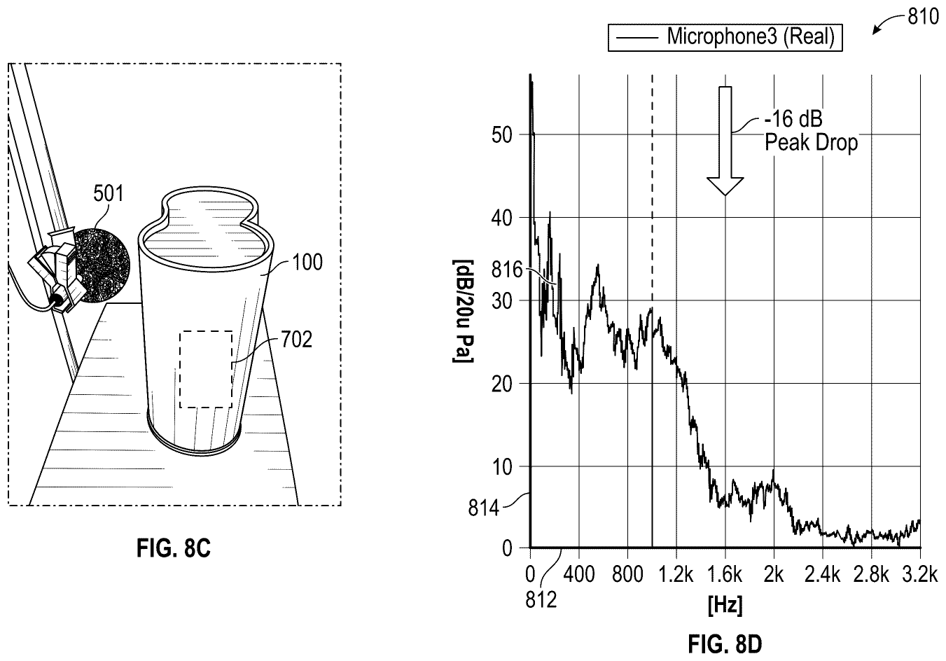

The outer layer 108 may include a plastic material. In some instances, the outer layer 108 may include acrylonitrile butadiene styrene (ABS), thermoplastic polyurethane (TPU), thermoplastic elastomers (TPE), or the like. Any suitable plastic material may be used herein. In this manner, each of the inner layer 104, the middle layer 106, and the outer layer 108 are configured to attenuate sound over a large frequency band, which will be described in greater detail below with reference to FIGS. 7A-8D. Any of these layers may be made from any suitable material described herein or otherwise.

FIG. 1B illustrates a top down view of the compressor jacket 100 in accordance with one or more embodiments of the present disclosure. The compressor jacket 100 may include a top cover 112. The top cover 112 (in connection with the base 102, the inner layer 104, the middle layer 106, and the outer layer 108) may be configured to surround a compressor area 114 and an accumulator area 116. In some instances, the top cover 112 may be removable. In other instances, the top cover 112 may be integral with the base 102, the inner layer 104, the middle layer 106, and/or the outer layer 108. The compressor area 114 may be sized and shaped to house a compressor therein. Similarly, the accumulator area 116 may be sized and shaped to house an accumulator therein. In this manner, the compressor area 114 and accumulator area 116 may be any number of different sizes and/or shapes. In this manner, the compressor jacket 100 may be configured to cover a compressor, which may reside within the compressor area 114, and an accumulator, which may reside within the accumulator area 116. The top cover 112 may be configured to cover the compressor area 114 and the accumulator area 116, resulting in the compressor jacket 100 completely surround both the compressor and/or the accumulator other than at the openings to the compressor area 114 and the accumulator area 116, which may be disposed opposite the top cover 112. In some instances, the top cover 112 may include an inner layer, a middle layer, and an outer layer, which all may correspond to, have a similar construct as, and be made of a similar material as the respective inner layer 104, middle layer 106, and outer layer 108.

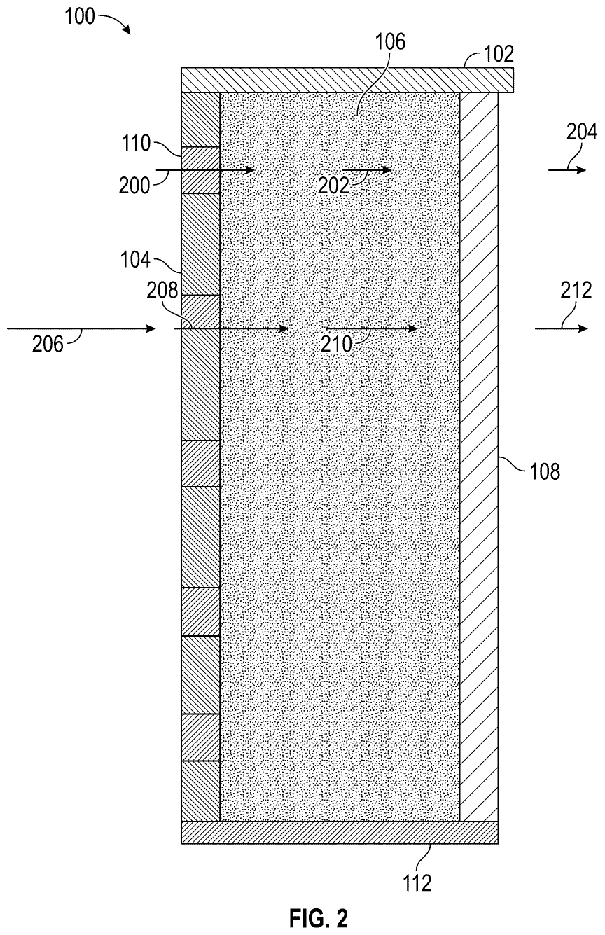

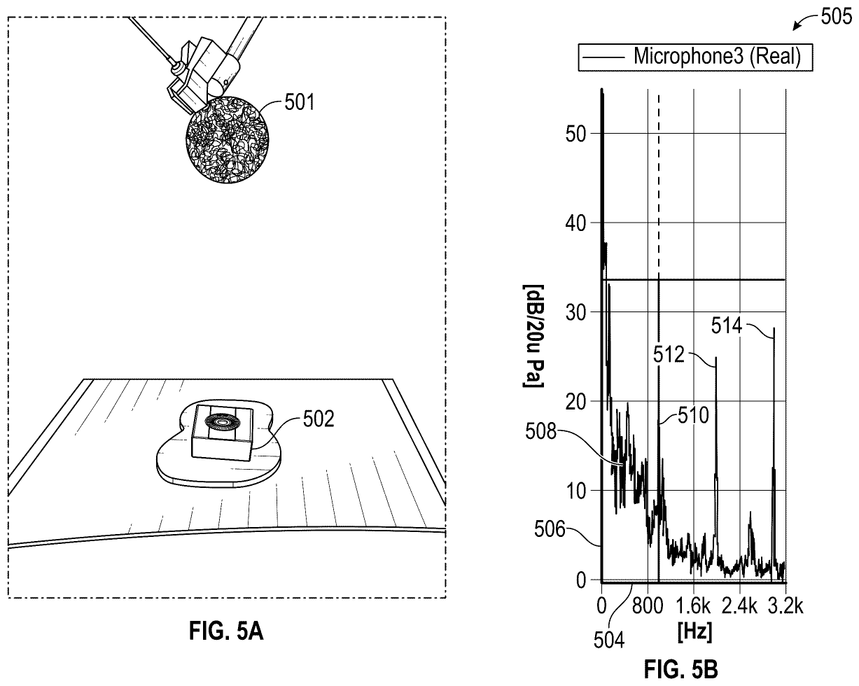

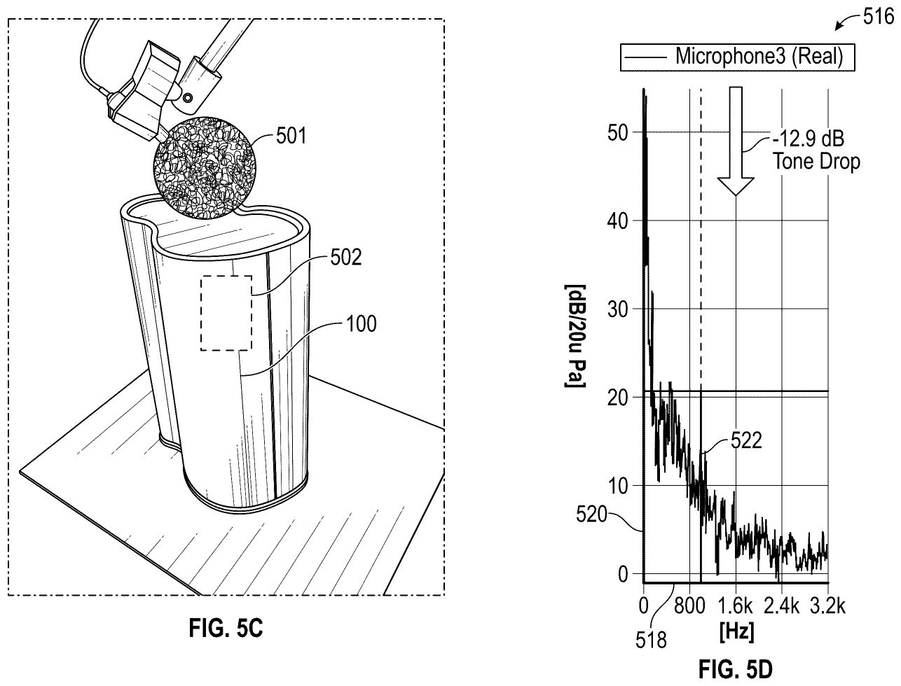

FIG. 2 illustrates a cross-sectional view along the line A-A of FIG. 1B of the compressor jacket 100 in accordance with one or more embodiments of the present disclosure. During operation of the compressor and/or the accumulator, the compressor and/or the accumulator may generate noise that includes broadband noise within a band of frequencies and a plurality of tonal noises. Tonal noise, also known as pure tone, is characterized by a single frequency or a narrow band of frequencies. Broadband noise is characterized by a summation of a wide range of frequency sound waves, each having a distinct respective amplitude, that are spread across the noise spectrum. This type of noise has no distinct pitch. The compressor jacket 100 may be configured to wholly or partially attenuate the broadband noise and the plurality of tonal noises of the compressor and/or the accumulator disposed therein. Further details about the attenuation are provided at least in the description associated with FIGS. 5A-8D.

In certain embodiments, the middle layer 106 may be adept at attenuating tonal sounds made by the compressor and/or the accumulator. For example, as depicted in FIG. 2, an arrow 200 represents a tonal sound wave emitted from the compressor and/or the accumulator. The width of the arrow 200 represents the width of the band of frequencies in the tonal sound, whereas the tonal sound wave has a specific amplitude in decibels (dB) that is represented by the length of the arrow 200. The tonal sound wave may pass through the holes 110 of the inner layer 104 and into the middle layer 106. The fibrous material within the middle layer 106 may be configured to absorb some of the energy of the tonal sound wave as the tonal sound wave passes through the middle layer 106. The fibrous material within the middle layer may convert that absorbed energy into heat. Because some of the energy of the tonal sound wave may be absorbed, the amplitude of the tonal sound wave may be attenuated. An arrow 202 represents the tonal sound wave emitted from the compressor and/or the accumulator after having been attenuated in amplitude by passing through the middle layer 106. This attenuation is represented with the arrow 202 having a length that is much shorter than the length of the arrow 200.

The material of the outer layer 108 additionally may be configured to absorb some of the energy of the tonal sound wave and convert the absorbed energy into heat. Because more of the energy of the tonal sound wave may be absorbed, the amplitude of the tonal sound wave may be further attenuated. An arrow 204 represents the tonal sound wave emitted from the compressor and/or the accumulator after having been further attenuated in amplitude by passing through the outer layer 108. This is represented with the arrow 204 having a length that is shorter than the length of the arrow 202.

Furthermore, in certain embodiments, the inner layer 104, the middle layer 106, and the outer layer 108 together may attenuate broadband sounds made by the compressor and/or the accumulator. For example, as depicted in FIG. 2, an arrow 206 represents a broadband sound wave emitted from the compressor and/or the accumulator. The width of the arrow 206 represents the width of the band of frequencies in the broadband sound. In this case, the broadband sound wave includes a much broader band of frequencies than that of the tonal sound wave. Accordingly, the width of the arrow 206 is much wider than the width of the arrow 200. The broadband sound wave has multiple amplitudes for its constituent frequencies, wherein the overall amplitude in dB is represented by the length of the arrow 206. The broadband sound wave passes through the inner layer 104 and into the middle layer 106. When passing through the inner layer 104, the broadband sound wave may pass through the material of the inner layer 104 and the holes 110 of the inner layer 104. Although it is difficult to represent the band of frequencies with a single arrow icon, it should be noted that certain frequency bands, i.e., certain tones, within the entire band of frequencies of the broadband sound wave may pass more readily through the holes of the inner layer 104. For this reason, the amplitudes of these respective tones will not be attenuated by the inner layer 104. However, the remaining portions of the band of frequencies of the broadband sound wave may pass through the material of the inner layer 104. The material of the inner layer 104 is configured to absorb some of the energy of the remaining portions of the band of frequencies of the broadband sound wave that pass through the inner layer 104. The material of the inner layer 104 may be configured to convert the absorbed energy into heat. Because some of the energy of the remaining portions of the band of frequencies of the broadband sound wave is absorbed, the amplitude of the remaining portions of the band of frequencies of the broadband sound wave are attenuated. This is represented with the arrow 208 having a length that is shorted than the length of the arrow 206.

The fibrous material within the middle layer 106 is configured to absorb some of the energy of all of the frequencies of the broadband sound wave as the broadband sound wave passes through the middle layer 106. The fibrous material within the middle layer 106 may convert that absorbed energy into heat. Because some of the energy of all the frequencies of the broadband sound wave is absorbed, the amplitudes of all the respective frequencies of the broadband sound wave may be attenuated. An arrow 210 represents the broadband sound wave emitted from the compressor and/or the accumulator after having been attenuated in amplitude by passing through the middle layer 106. This attenuation is represented with the arrow 210 having a length that is shorter than the length of the arrow 208.

The material of the outer layer 108 is configured to additionally absorb some of the energy of all the frequencies of the broadband sound wave and convert that absorbed energy into heat. Because more of the energy of all the frequencies of the broadband sound wave is absorbed, the amplitude of the broadband sound wave is further attenuated. An arrow 212 represents the broadband sound wave emitted from the compressor and/or the accumulator after having been further attenuated in amplitude by passing through the outer layer 108. This is represented with the arrow 212 having a length that is shorter than the length of the arrow 210.

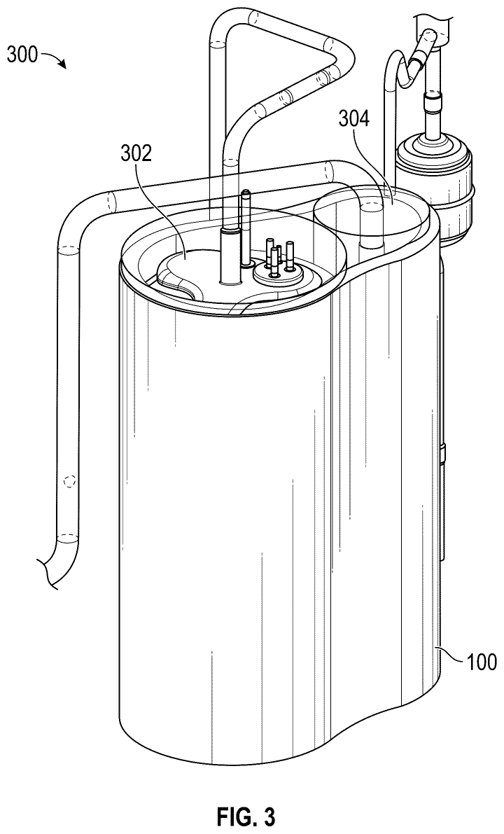

The attenuation of tonal and broadband sound will be described in greater detail with reference to FIG. 3, which illustrates an example heat transfer system 300 in accordance with one or more embodiments of the present disclosure. In certain embodiment, the heat transfer system 300 includes the compressor jacket 100 (with the top cover 112 removed for clarity), which surrounds a compressor 302 and an accumulator 304.

In certain embodiments, the accumulator 304 may be a device used with the compressor 302 in the heat transfer system 300. The function of the accumulator 304 may be to store excess refrigerant, as well as protecting the compressor 302 from damage by storing excess refrigerant. While the compressor 302 is running, the compressor 302 and the accumulator 304 may generate noise, including both tonal and broadband noise. However, with the compressor jacket 100 being placed over the compressor 302 and the accumulator 304, the noise created by the compressor 302 and the accumulator 304 may be at least partially attenuated.

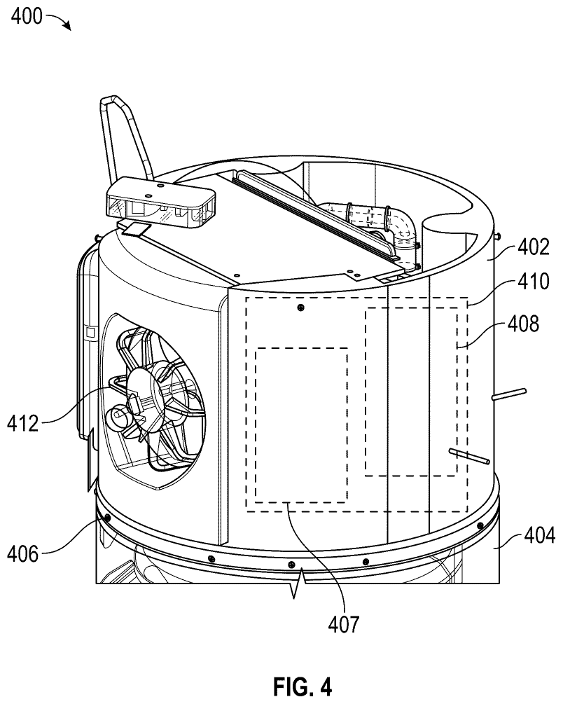

The compressor jacket 100 may be configured to fit around both the compressor 302 and the accumulator 304. However, the size, shape, and configuration of the compressor jacket 100 may be varied to fit around other components of the heat transfer systems to help reduce overall noise. This will be described in greater detail with reference to FIG. 4.

FIG. 4 illustrates an example heat transfer system 400 in accordance with one or more embodiments of the present disclosure. As depicted in FIG. 4, the heat transfer system 400 may include a housing 402 disposed above a water tank 404. A base plate 406 or the like may be disposed between the water tank 404 and the housing 402. The housing 402 may be sized and shaped to house one or more components of the heat pump system therein. For example, the housing 402 may include a compressor 407 and/or an accumulator 408 therein. The housing 402 may also include a fan 412, which may be a component of the heat pump system. For example, the fan 412 may move air over one or more heating coils of the heat pump. Similar to the compressor 407 and/or the accumulator 408, the fan 412 may generate noise when operating.

In certain embodiments, a compressor jacket 410 may be disposed about the compressor 407 and/or accumulator 408 within the housing 402. The compressor jacket 410 may be similar to the compressor jacket 100 discussed above. In this manner, base of the compressor jacket 410 may be configured to rest on a surface of the base plate 406 so as to surround the compressor and/or the accumulator 408. The base of the compressor jacket 410 and the base plate 406 may form a seal therebetween to reduce noise generated by the compressor 407 and/or accumulator 408.

In some instances, the walls of the housing 402 may form the compressor jacket to attenuate the sounds of the heat transfer system 400 in a similar fashion to that of the compressor jacket 100. That is, the walls of the housing 402 may include an inner layer having a plurality holes, a middle layer that is exposed by the plurality of holes of the inner layer, and an outer layer in a manner similar to the compressor jacket 100 discussed above. In some instances, when the walls of the housing 402 form the compressor jacket, the compressor jacket 410 may be omitted. In other instances, when the walls of the housing 402 form the compressor jacket, the compressor jacket 410 may be included to further attenuate the sounds of the heat transfer system 400.

FIGS. 5A-8D illustrate sound attenuation of the compressor jacket 100 in more detail.

FIG. 5A illustrates an audio test setup, including a microphone 501 and a sound device 502. FIG. 5B illustrates a sound graph 505 associated with the audio test setup of the microphone 501 and the sound device 502 of FIG. 5A. The microphone 501 is configured to capture audio, whereas the sound device 502 was configured to generate sound that emulates the sound generated by a compressor of a heat pump water heater. In the test setup of FIG. 5A, the sound device generated broadband sound over a frequency band from 0 to 3.2 KHz, with a superposition of a tonal sounds at approximately 1.0 KHz, 2.0 KHz, and 3.0 KHz., wherein the overall amplitude is a maximum of 94 decibels.

As shown in FIG. 5A, the microphone 501 was positioned directly above the sound device 502 to emulate sound rising up and out from a compressor. The microphone 501 captured the audio produced by the sound device 502. The sound was processed, for example via a Fourier transform or fast Fourier transform (FFT), to break down the recorded sound into its constituent frequency components with their corresponding amplitude. This transformed data was used to produce the sound graph 505. The sound graph 505 includes an x-axis 504 of frequency in hertz (Hz), a y-axis 506 of sound pressure level in dB/20 μPa, and a sound function 508 that includes spikes 510, 512, and 514.

The units of a detected sound given as “dB/u Pa” are decibels per micro Pascal (dB/μPa). This is a unit of sound pressure level (SPL), which is a measure of the pressure variation caused by a sound wave in a medium, such as air. The use of the micro Pascal (μPa) as a reference unit is common in acoustics and represents the threshold of human hearing at a frequency of 1000 Hz. The decibel (dB) is a logarithmic unit that compares the measured sound pressure level to a reference level, often the minimum audible threshold. Therefore, “dB/μPa” describes the ratio of the sound pressure level to the reference level of 1 micro Pascal. It is a common unit used in acoustics and audio engineering to measure the loudness of sounds.

The spikes 510, 512, and 514 are sharp changes in the dB level of the sound data 508, known as tonal sounds. For example, portions within the band from 0 to 3.2 KHz other than that of the spikes 510, 512, and 514 represent the broadband noise and may be described as a constant sound. On the other hand, the spikes 510, 512, and 514 represent tonal noises, wherein each one may be described as a sharp, distinct tone such as that from a bell.

In certain embodiments, the three-layer compressor jacket of the present disclosure attenuates both (i) the broadband noise, e.g., the portions within the band from 0 to 3.2 KHz other than that of the spikes 510, 512, and 514 and (ii) the tonal noise, e.g., the spikes 510, 512, and 514. In particular, if all the tonal content is removed from the graph 505, then the graph 505 would represent the broadband noise from a source. In one or more embodiments of a three-layer compressor jacket of the present disclosure includes TPE and TPU materials that are used to attenuate the high frequency broad band noise. On the other hand, the tonal contents are in the low frequency bands and hard to remove using polymers. For this reason, in accordance with one or more embodiments of the present disclosure, loose glass fibers with long strands are used in the middle layer 106 to convert the low frequency noise energy into the thermal energy to reduce low frequency noise, including tonal contents. The loose glass fibers may be any suitable length any diameter. As one non-limiting example, the loose glass fibers may be between 1 and 1000 mm.

FIG. 5C illustrates an audio test set up including the microphone 501 and a compressor jacket 100 in accordance with one or more embodiments of the present disclosure. Within the compressor jacket 100 is the sound device 502. FIG. 5D illustrates a sound graph 516 associated with the audio test setup of the microphone 501 and the sound device 502 encased within the compressor jacket 100, as shown in FIG. 5C.

As shown in FIG. 5C, the microphone 501 was positioned directly above the compressor jacket 100. The sound device 502 was surrounded by the compressor jacket 100. It should be noted that the sound device 502 was configured to generate sound that emulates the sound generated by a compressor. However, as compared to the test setup of FIG. 5A, in the test setup of FIG. 5C, the sound device 502 is surrounded by the compressor jacket 100.

The sound device 502 (covered by the compressor jacket 100) generated broadband sound over a band from 0 to 3.2 KHz, with a superposition of a tonal sound at approximately 1.0 KHz, 2.0 KHz, and 3.0 KHz, wherein the overall amplitude was a maximum of 94 dB, generated by a reference sound source, inside the compressor jacket 100 for the testing. The microphone 501 was positioned directly above the compressor jacket 100, which surrounded the sound device 502 to emulate sound rising up and out from a compressor and through the top of the compressor jacket 100. The microphone 501 captured the audio produced by the sound device 502. The sound was processed, for example via a Fourier transform or an FFT, to break down the recorded sound into its constituent frequency components with their corresponding amplitude. This transformed data is used to produce the sound graph 516 of FIG. 5D. The sound graph 516 includes an x-axis 518 of frequency in hertz (Hz), a y-axis 520 of sound pressure level in dB/20 μPa, and a sound function 522.

When comparing the sound graph 505 of FIG. 5B to the sound graph 516 of FIG. 5D, the spike 510, the spike 512, and the spike 514 of the sound graph 505 have attenuated by approximately 12.9 dBs (however, this amount of attenuation is merely exemplary and the attenuation may be any other value). This is due to the sound device 502 being covered by the compressor jacket 100, which is adept at lowering tonal noises. More specifically, as discussed above, the middle layer 104 of the compressor jacket 100, in some instances made of a high density fiber glass, is able to absorb tonal sounds to lower the volume of tonal sounds. The density of the high density fiber glass may be any density known in the art. Additionally, any other density fiber glass may also be used.

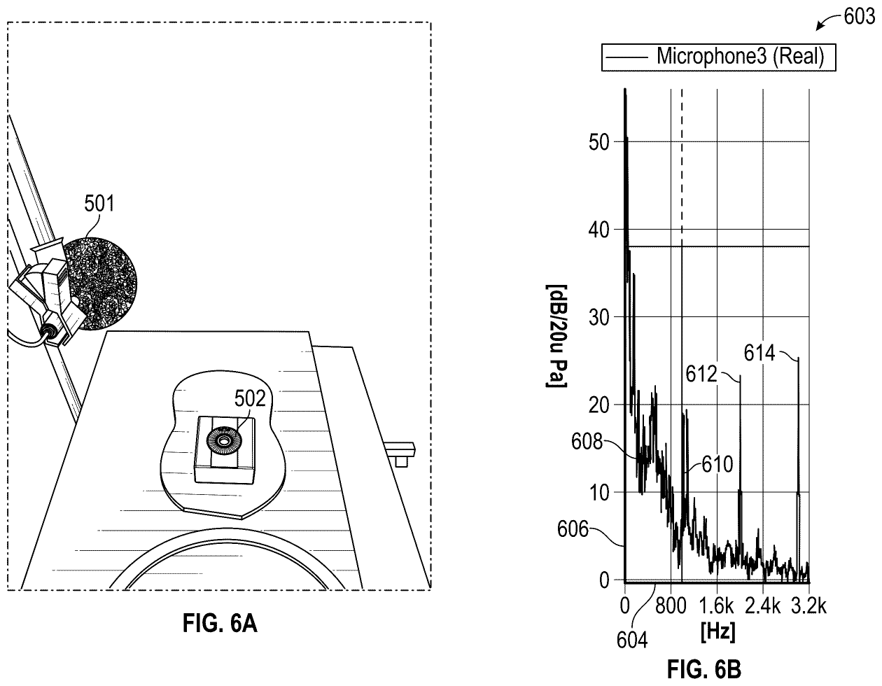

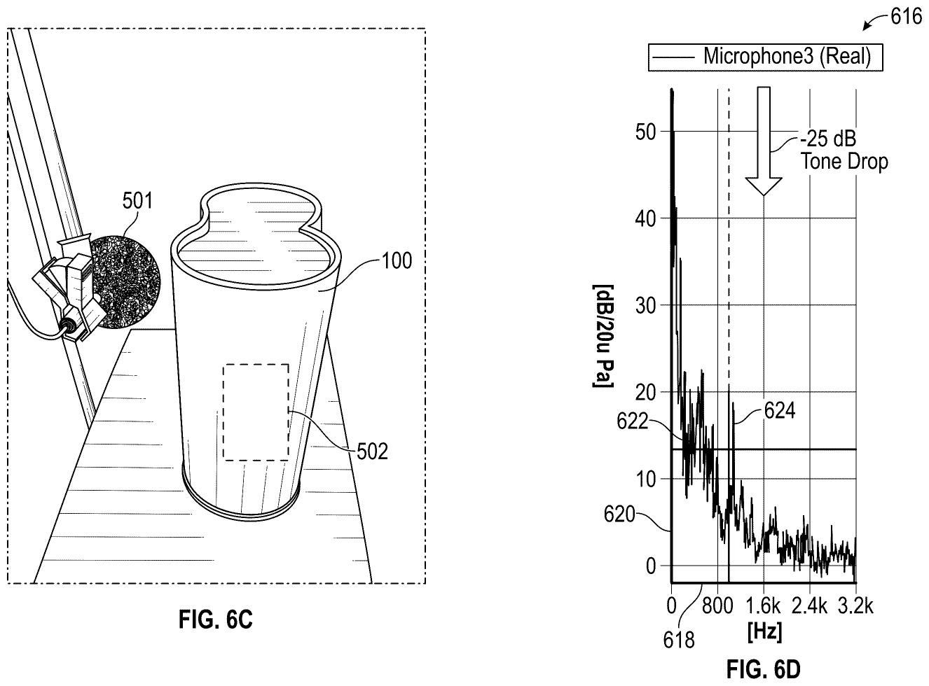

FIG. 6A illustrates an audio test setup including the microphone 501 and the sound device 502. FIG. 6B illustrates a sound graph 603 associated with the audio test setup of the microphone 501 and the sound device 502 of FIG. 6A.

As shown in FIG. 6A, the microphone 501 was placed to the side of the sound device 502 rather than the microphone 501 being placed above the sound device 502. The microphone 501 captured the audio produced by the sound device 502 to produce the sound graph 603. The sound graph 603 includes an x-axis 604 of frequency in hertz (Hz), a y-axis 606 of sound pressure level in dB/20 μPa, and a sound function 608 that includes spikes 610, 612, and 614. The spikes 610, 612, and 614 are sharp changes in the dB level of the sound function 608, e.g., tonal sounds. For example, portions within the band from 0 to 3.2 KHz other than that of the spikes 610, 612, and 614 represent the broadband noise. On the other hand, the spikes 610, 612, and 614 represent tonal noises. In certain embodiments, the compressor jacket of the present disclosure attenuates both (i) the broadband noise, e.g., the portions within the band from 0 to 3.2 KHz other than that of the spikes 610, 612, and 614 and (ii) the tonal noise, e.g., the spikes 610, 612, and 614.

FIG. 6C illustrates another audio test setup including the microphone 501 and the compressor jacket 100 in accordance with one or more embodiments of the present disclosure. The compressor jacket 100 surrounded the sound device 502. FIG. 6D illustrates a sound graph 616 associated with the audio set up of the microphone 501 and the sound device 502 encased within the compressor jacket 100 of FIG. 6C. The microphone 501 was placed to the side of the compressor jacket 100, which surrounded the sound device 502. It should be noted that the sound device 502 was configured to generate sound that emulates the sound generated by a compressor. However, as compared to the test setup of FIG. 6A, in the test setup of FIG. 6C, the sound device 502 was surrounded by the compressor jacket 100.

The sound device (covered by the compressor jacket 100) generated broadband sound over a band from 0 to 3.2 KHz, with a superposition of a tonal sound at approximately 1.0 KHz, 2.0 KHz, and 3.0 KHz. The microphone 501 was positioned to the side the compressor jacket 100, which surrounded the sound device 502 to emulate sound from a compressor and through the side of the compressor jacket 100. The microphone 501 captured the audio produced by the sound device 502. That sound was processed, for example via a Fourier transform or an FFT, to break down the recorded sound into its constituent frequency components with their corresponding amplitude. This transformed data was used to produce the sound graph 616 of FIG. 6D. The sound graph 616 includes an x-axis 618 of frequency in hertz (Hz), a y-axis 620 of sound pressure level in dB/20 μPa, and a sound function 622, which includes a spike 624.

When comparing the sound graph 603 of FIG. 6B to the sound graph 616 of FIG. 6D, the spike 612 and the spike 614 have been removed, and the spike 610 of the sound graph 603 has been attenuated by approximately 25 dBs. This is due to the sound device 502 being covered by the compressor jacket 100, which is adept at lowering tonal noises. More specifically, as discussed above, the middle layer 104 of the compressor jacket 100, in some instances made of a high density fiber glass, is able to absorb tonal sounds to lower the volume of tonal sounds.

As shown in FIGS. 5D and 6D, the compressor jacket 100 successfully lowered the tonal noises made by the sound device 502, whether the microphone was above the compressor jacket 100 or to the side of the compressor jacket 100. Not only did the compressor jacket attenuate tonal noises, but the compressor jacket additionally attenuated broadband noise. FIGS. 7A-8D describe how the compressor jacket attenuates broadband noise.

FIG. 7A illustrates another audio test setup including the microphone 501 and the sound device 702. The microphone 501 was positioned above the sound device 702. FIG. 7B illustrates a sound graph 703 associated with the test setup of FIG. 7A. The microphone 501 captured audio, whereas the sound device 702 was configured to generate sound that emulates the sound generated by a fan to be surrounded by the compressor jacket 100. In the test setup of FIG. 7A, the sound device generated broadband sound over a frequency band from 0 to 3.2 KHz. The microphone 501 was positioned directly above the sound device 702 to emulate sound rising up and out from a fan. The microphone 501 captured the audio produced by the sound device 702. The sound was processed, for example via a Fourier transform or an FFT, to break down the recorded sound into its constituent frequency components with their corresponding amplitude. This transformed data was used to produce the sound graph 703. The sound graph 703 includes an x-axis 704 of frequency in hertz (Hz), a y-axis 706 of sound pressure level in dB/20 μPa, and a sound function 708 that represent the broadband noise and may be described as a constant sound. It should be noted that the sound generated from the sound device 702 does not include any tonal sounds, as evidenced by a lack of spikes in the sound function 708.

FIG. 7C illustrates an audio test set up including the microphone 501 and a compressor jacket 100 in accordance with one or more embodiments of the present disclosure. The compressor jacket 100 surrounds the sound device 702. FIG. 7D illustrates a sound graph 710 associated with the audio test setup of the microphone 501 and the sound device 702 encased within the compressor jacket 100 of FIG. 7C. The microphone 501 was positioned directly above the compressor jacket 100, which surrounded the sound device 702. It should be noted that the sound device 702 was configured to generate sound that emulates the sound generated by a fan of a heat pump system. However, as compared to the test setup of FIG. 7A, in the test setup of FIG. 7C, the sound device 702 was surrounded by the compressor jacket 100.

The sound device (covered by the compressor jacket 100) generated broadband sound over a band from 0 to 3.2 KHz. The microphone 501 was positioned directly above the compressor jacket 100, which surrounded the sound device 702 to emulate sound rising up and out from a fan and through the top of the compressor jacket 100. The microphone 501 captured the audio produced by the sound device 702. That sound was processed, for example via a Fourier transform or an FFT, to break down the recorded sound into its constituent frequency components with their corresponding amplitude. This transformed data is used to produce the sound graph 710 of FIG. 7D. The sound graph 710 includes an x-axis 712 of frequency in hertz (Hz), a y-axis 714 of sound pressure level in dB/20 μPa, and a sound function 716.

When comparing the sound graph 703 of FIG. 7B to the sound graph 710 of FIG. 7D, there is a peak drop of 18 dB. This is due to the sound device 702 being covered by the compressor jacket 100, which is adept at lowering broadband noise. More specifically, as discussed above, the combination of the inner layer 102, middle layer 104, and the outer layer 108 of the compressor jacket 100 absorb broadband sounds to lower the volume of broadband sounds.

FIG. 8A illustrates an audio test setup including the microphone 501 and the sound device 702. FIG. 8B illustrates a sound graph 803 associated with audio test setup of the microphone 501 and the sound device 702 as shown in FIG. 8A. The microphone 501 was placed to the side of the sound device 702, rather than the microphone 501 being placed above the sound device 702. The microphone 501 captured the audio produced by the sound device 702 to produce the sound graph 803. The sound graph 803 includes an x-axis 804 of frequency in hertz (Hz), a y-axis 806 of sound pressure level in dB/20 μPa, and a sound function 808 that represent the broadband noise and may be described as a constant sound. It should be noted that the sound generated from the sound device 702 does not include any tonal sounds, as evidenced by a lack of spikes in the sound function 808.

FIG. 8C illustrates another audio test setup including the microphone 501 and the compressor jacket 100 in accordance with one or more embodiments of the present disclosure. The compressor jacket 100 surrounded the sound device 702. FIG. 8D illustrates a sound graph 810 associated with audio set up of the microphone 501 with the sound device 702 encased within the compressor jacket 100 of FIG. 8C. The microphone 501 was placed to the side of the compressor jacket 100, which surrounded the sound device 702. It should be noted that the sound device 702 was configured to generate sound that emulates the sound generated by a fan of a heat pump system. However, as compared to the test setup of FIG. 8A, in the test setup of FIG. 8C, the sound device 702 was surrounded by the compressor jacket 100. The sound device (covered by the compressor jacket 100) generated broadband sound over a band from 0 to 3.2 KHz, with a superposition of a tonal sound at approximately 1.0 KHz, 2.0 KHz, and 3.0 KHz. The microphone 501 captured the audio produced by the sound device 702. The sound was processed, for example via a Fourier transform or an FFT, to break down the recorded sound into its constituent frequency components with their corresponding amplitude. This transformed data is used to produce the sound graph 810 of FIG. 8D. The sound graph 810 includes an x-axis 812 of frequency in hertz (Hz), a y-axis 814 of sound pressure level in dB/20 μPa, and a sound function 816.

When comparing the sound graph 803 of FIG. 8B to the sound graph 810 of FIG. 8D, there is a peak drop of 16 dB. This is due to the sound device 702 being covered by the compressor jacket 100, which is adept at lowering broadband noise. More specifically, as discussed above, the combination of the inner layer 102, middle layer 104, and the outer layer 108 of the compressor jacket 100 are configured to absorb broadband sounds to lower the volume of broadband sounds.

As shown in FIGS. 7D and 8D, the compressor jacket 100 successfully lowers the broadband noise made by the sound device 702, whether the microphone was above the compressor jacket 100 or to the side of the compressor jacket 100. The test setups of FIGS. 5C, 6C, 7C, and 8C all use the compressor jacket 100. However, as stated above, the compressor jacket 100 may be shaped differently, a non-limiting example shape being similar to that of the compressor jacket 402 of FIG. 4. All of the compressor jacket examples described may include an inner layer with a plurality of holes, a middle layer that is exposed by the plurality of holes of the inner layer, and an outer layer. More specifically, the inner layer may include a plastic material comprising thermoplastic polyurethane, polyethylene terephthalate, or combinations thereof, the middle layer may be a high density fiber glass, and the outer layer may include a plastic material, such as a thermoplastic polyurethane. In this manner, all of the compressor jackets may be configured to attenuate both tonal and broadband sound.

While the present disclosure has been described in connection with a plurality of exemplary aspects, as illustrated in the various figures and discussed above, it is understood that other similar aspects can be used, or modifications and additions can be made to the described subject matter for performing the same function of the present disclosure without deviating therefrom. In this disclosure, methods and compositions were described according to aspects of the presently disclosed subject matter. But other equivalent methods or compositions to these described aspects are also contemplated by the teachings herein. Therefore, the present disclosure should not be limited to any single aspect, but rather construed in breadth and scope in accordance with the appended claims.

Moreover, the various diagrams and figures presented herein are for illustrative purposes and are not to be considered exhaustive. That is, the systems described herein can include one or more additional components, such as various valves, expansions tanks, and the like, as will be appreciated by one having ordinary skill in the art.

That which is claimed is:

1. A jacket for use with a compressor of a heat transfer system, the compressor being configured to operate and emit sound over a frequency band during operation, the jacket comprising:
an inner wall configured to surround the compressor, the inner wall comprising a first material and having a plurality of openings configured to attenuate a first volume of a first frequency within the frequency band of the sound;
a middle layer surrounding the inner wall, the middle layer comprising a second material configured to attenuate a second volume of a second frequency within the frequency band of the sound; and
an outer layer surrounding the middle layer.

2. The jacket of claim 1, wherein the first material is different from the second material.

3. The jacket of claim 1, wherein the first material comprises a plastic material comprising thermoplastic polyurethane, polyethylene terephthalate, acrylonitrile butadiene styrene, thermoplastic elastomers, and combinations thereof.

4. The jacket of claim 1, wherein the second material comprises glass wool fiber.

5. The jacket of claim 1, further comprising:
a bottom having an opening configured to receive the compressor when the jacket is disposed thereon; and
a pad disposed on the bottom and configured to fit around the opening.

6. The jacket of claim 1, wherein:
the inner wall surrounds a first volume of space and a second volume of space,
the first volume of space is configured so as to accommodate the compressor,
the second volume of space is configured so as to accommodate an accumulator of the heat transfer system, and
the first volume is greater than the second volume.

7. The jacket of claim 1, wherein:
the outer layer comprises a third material, and
the first material, the second material, and the third material are configured to attenuate a third volume of a second frequency band within the frequency band of the sound.

8. A water heater comprising:
a water tank;
a heat transfer system configured to transfer heat to the water tank, wherein the heat transfer system comprises a compressor, and wherein the compressor emits sound over a frequency band during operation; and
a jacket comprising:
an inner wall configured to surround the compressor, wherein the inner wall comprises a first material having a plurality of openings configured to attenuate a first volume of a first frequency within the frequency band of the sound;
a middle layer surrounding the inner wall, wherein the middle layer comprises a second material configured to attenuate a second volume of a second frequency within the frequency band of the sound; and
an outer layer surrounding the middle layer.

9. The water heater of claim 8, wherein the first material is different from the second material.

10. The water heater of claim 8, wherein the first material comprises a plastic material comprising thermoplastic polyurethane, polyethylene terephthalate, acrylonitrile butadiene styrene, thermoplastic elastomers, and combinations thereof.

11. The water heater of claim 8, wherein the second material comprises glass wool fiber.

12. The water heater of claim 8, wherein the jacket further comprises:
a bottom having an opening configured to receive the compressor when the jacket is disposed thereon; and
a pad disposed on the bottom and configured to fit around the opening.

13. The water heater of claim 8, wherein:
the inner wall surrounds a first volume of space and a second volume of space,
the first volume of space is configured so as to accommodate the compressor,
the second volume of space is configured to accommodate an accumulator of the heat transfer system, and
the first volume is greater than the second volume.

14. The water heater of claim 8, wherein:
the outer layer comprises a third material, and
the first material, the second material, and the third material are configured to attenuate a third volume of a second frequency band within the frequency band of the sound.

15. A system comprising:
a heat pump water heater comprising a compressor which emits sound; and
a jacket comprising:
an inner wall configured to surround the compressor, wherein the inner wall comprises a first material having a plurality of openings configured to attenuate a first volume of a first frequency within a frequency band of the sound;
a middle layer surrounding the inner wall, wherein the middle layer comprises a second material configured to attenuate a second volume of a second frequency within the frequency band of the sound; and
an outer layer surrounding the middle layer.

16. The system of claim 15, wherein the first material comprises thermoplastic polyurethane, polyethylene terephthalate, acrylonitrile butadiene styrene, thermoplastic elastomers, and combinations thereof.

17. The system of claim 15, wherein the second material comprises glass wool fiber.

18. The system of claim 15, wherein the jacket further comprises:
a bottom having an opening configured to receive the compressor when the jacket is disposed thereon; and
a pad disposed on the bottom and configured to fit around the opening.

19. The system of claim 15, wherein:
the inner wall surrounds a first volume of space and a second volume of space,
the first volume of space is configured so as to accept receipt of the compressor,
the second volume is configured so as to accept receipt of an accumulator of the heat pump system, and
the first volume is greater than the second volume.

20. The system of claim 15, wherein:
the outer layer comprises a third material, and
the first material, the second material, and the third material are configured to attenuate a third volume of a second frequency band within the frequency band of the sound.
